(19) United States
(12) Patent Application Publication
(10) Pub. No.: US 2003/0153715 A1
(43) Pub. Date: Aug. 14, 2003

(54) Diphenylmethane diisocyanate compositions

(76) Inventor: Wolfgang Pille-Wolf, Tervuren (BE)

Correspondence Address: Patent Counsel, Huntsman Polyurethanes, 286 Mantua Grove Road, West Deptford, NJ, 08066-1732, US

(21) Appl. No.: 10/336,347

(22) Filed: Jan. 3, 2003

Related U.S. Application Data
(63) Continuation of application No. PCT/EP01/07364, filed on Jun. 28, 2001.

(30) Foreign Application Priority Data
Jul. 27, 2000 (EP) 00116089.4

(51) Int. Cl. C08G 18/10

(52) U.S. Cl. 528/59; 540/201

(57) ABSTRACT

Novel diphenylmethane diisocyanate composition that comprises diphenylmethane diisocyanate, a diphenylmethane diisocyanate uretonimine group-containing derivative, a reaction product of diphenylmethane diisocyanate and a diol of number average molecular weight less than 250 and optionally methylene bridged polyphenyl polyisocyanates of isocyanate functionality higher than two, the composition having a content of 2,4 isomer between 2 and 50%. The novel composition is highly stable. The invention also provides a process for its preparation, process for making polyurethane articles using the composition of the invention, as well as the polyurethane articles thus obtained.

### CROSS REFERENCE TO RELATED APPLICATIONS

This application is a continuation of international application PCT EP01/07364, filed Jun. 28, 2001.

### FIELD OF THE INVENTION

This invention relates to diphenylmethane diisocyanate compositions that comprise diphenylmethane diisocyanate together with diphenylmethane diisocyanate uretonimine group-containing derivatives, reaction products of diphenylmethane diisocyanate and certain diols and optionally methylene bridged polyphenylpolyisocyanates of isocyanate functionality greater than two. The invention also relates to the preparation of such compositions and their use in the manufacture of polyurethanes.

### BACKGROUND OF THE INVENTION

It is well known that diphenylmethane diisocyanate can be used to prepare a wide range of polyurethanes such as surface coatings, foams and elastomers having valuable properties. Refined diphenylmethane diisocyanate, refined by either distillation, crystallisation or a combination of these processes, is normally a solid, melting at about 40° C., and therefore has the disadvantage that it is difficult to handle on the large scale, requiring melting before it can be metered. It also suffers from the defect that on storage in the solid crystalline state slow conversion to uretedione derivatives takes place and as such derivatives are of low solubility, the liquid obtained on melting the diisocyanate is cloudy and difficulty may be experienced in metering the liquid which has first to be filtered.

Various methods of overcoming these disadvantages have been proposed and have generally been aimed at producing diphenylmethane diisocyanate compositions which are liquid at low temperatures or have a greatly reduced tendency to crystallise on storage at those temperatures. Since these compositions are used amongst others as curing agents for floor coatings, encapsulants and other materials or are used as starting materials for the manufactuer of prepolymers it is necessary to transport and stock these compositions under outdoor conditions even during cold seasons. Thus, various compositions have been made in which a proportion of the isocyanate groups are reacted with hydroxy compounds or are converted to carbodiimide and thus to uretonimine groups.

### SUMMARY OF THE INVENTION

We have now surprisingly found that certain diphenylmethane diisocyanate compositions which contain both uretonimine and urethane residues are liquids being permanently storage stable at low temperatures of 0° C. and for several weeks storage stable at −10° C. eminently useful for the manufacture of polyurethanes microcellular, semi-rigid, integral skin foams, solid mouldings, encapsulants and coatings.

The compositions of the invention are notably stable at 5° C. for more than 90 days without crystallization and/or stable at 0° C. for at least one week without crystallization and/or stable at −10° C. for at least one day without crystallization.

Thus, according to the present invention there is provided a diphenylmethane diisocyanate composition which comprises diphenylmethane diisocyanate, a diphenylmethane diisocyanate uretonimine group-containing derivative, a reaction product of diphenylmethane diisocyanate and a diol or mixture of diols of number average molecular weight less than 250 and optionally methylene bridged polyphenyl polyisocyanates of isocyanate functionality higher than two, characterized in that the 2,4′-isomer content is from 3 to 35% (mol), and preferably 5 to 27%.

The invention also provides a process for the preparation of the compostion, process for making polyurethane articles using the composition, as well as the polyurethane articles thus obtained.

### DETAILED DESCRIPTION OF THE INVENTION

Thus, according to the present invention there is provided a diphenylmethane diisocyanate composition which comprises diphenylmethane diisocyanate, a diphenylmethane diisocyanate uretonimine group-containing derivative, a reaction product of diphenylmethane diisocyanate and a diol or mixture of diols of number average molecular weight less than 250 and optionally methylene bridged polyphenyl polyisocyanates of isocyanate functionality higher than two, characterized in that the 2,4′-isomer content is from 3 to 35% (mol), and preferably 5 to 27%. The compositions of the invention are notably stable at 5° C. for more than 90 days without crystallization and/or stable at 0° C. for at least one week without crystallization and/or stable at −10° C. for at least one day without crystallization.

Any diphenylmethane diisocyanate may be used in the composition or in the preparation of the uretonimine group-containing derivative and the diol/diphenylmethane diisocyanate reaction product (provided the 2,4′-isomer content condition is met). The term “diphenylmethane diisocyanate” as used herein encompasses pure 4,4-MDI with the required amount of 2,4′-isomer, as well as containing up to 5% of the 2,2′-isomer. A diphenylmethane diisocyanate uretonimine group-containing derivative is a uretonimine derived from diphenylmethane diisocyanate. Such derivatives may be made by converting a proportion of the isocyanate groups in diphenylmethane diisocyanate to carbodiimide groups and then allowing the carbodiimide groups to react with further isocyanate groups to give uretonimine groups. Thus, one of the simplest uretonimine group-containing derivatives would be formed from 3 molecules of diphenylmethane diisocyanate.

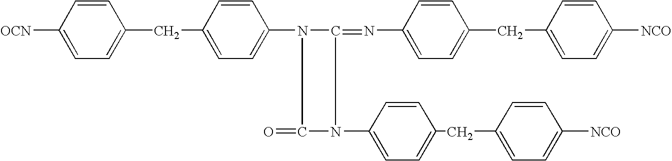

Uretonimine groups are produced by reacting an isocyanate group with a carbodiimide group and may be easily introduced into an isocyanate composition by converting some of the isocyanate groups to carbodiimide groups and then allowing the carbodiimide groups to react with unreacted isocyanate groups to form uretonimine groups. A large variety of phosphorus-containing catalysts have been described for use in the conversion of isocyanate groups to carbodiimide groups. The conversion of isocyanate groups to carbodiimide groups and the further reaction to give uretonimine groups is known in the art, and is, for example, described in GB-A-1,356,851 and in U.S. Pat. No. 4,014,935. Once carbodiimide groups have been introduced into an isocyanate composition, reaction between carbodiimide groups and isocyanate groups takes place with formation of uretonimine groups. In order to permit this reaction to proceed to near completion it is normally necessary to allow the isocyanate/carbodiimide reaction mixture to stand for a time at room temperature for the uretonimine-forming reaction to take place. Conversion to uretonimine may not go to absolute completion and there sometimes remains in the composition a small amount of carbodiimide which is not converted to uretonimine despite the presence of excess isocyanate groups.

In manufacturing diphenylmethane diisocyanate uretonimine group-containing derivatives for the compositions of this invention, it is preferred that about 3.5-35% of the isocyanate groups in diphenylmethane diisocyanate are converted to carbodiimide groups by heating the diisocyanate in the presence of a catalyst and then cooling the mixture, with deactivation of the catalyst if desired or necessary, and then allowing the carbodiimide groups to react further to give the uretonimine derivative. Thus, there is obtained diphenylmethane diisocyanate containing a uretonimine group-containing derivative thereof.

The reaction product of a diphenylmethane diisocyanate with a diol having a number average molecular weight of less than 250 may be any such product made using an appropriate diol or a mixture of diols. Examples of suitable diols include ethylene glycol, diethylene glycol, triethylene glycol, tripropylene glycol, 2-hydroxyethyl-2′-hydroxypropylether, 1,2-propylene glycol, 1,3-propylene glycol, dipropyl glycol, 1,2-, 1,3- and 1,4-butylene glycols, 1,5-pentane diol, bis-2-hydroxypropyl sulphide, bis-2-hydroxyalkyl carbonates, p-xylylene glycol, 4-hydroxymethyl-2,6-dimethyl phenol and 1,2-, 1,3- and 1,4-dihydroxy benzenes. Mixtures of diols may be used.

The reaction product may be suitably made by reacting a proportion of the isocyanate groups in a diphenylmethane diisocyanate with the diol and using the product which will contain both diisocyanate/diol reaction product and excess diisocyanate, in the present composition. Thus, if from 0.02 to 0.40 molar, preferably 0.03 to 0.25 molar, most preferably 0.05 to 0.10 molar, proportions of diol are reacted with 1 molar proportion of diphenylmethane diisocyanate then from 2 to 40%, resp. 3 to 25%, resp. 5 to 10%, of the isocyanate groups will be reacted. The conditions of reaction of isocyanates and diols are well known and although elevated temperature may be used this is not always necessary.

The fourth and optional component of the composition is methylene bridged polyphenyl polyisocyanates having an isocyanate functionality greater than two. The amount can be up to 75%, preferably between 0.1 and 50%, based on the composition weight. According to one embodiment, the content is 10 to 50%. According to another embodiment, the content is between 1 to 10%. Methylene bridged polyphenyl polyisocyanates of isocyanate functionality greater than two are well known and have the general formula:

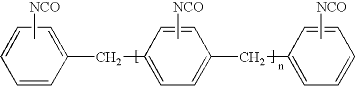

where n is one or more. They are produced together with diphenylmethane diisocyanates by phosgenation of the condensation product of aniline and formaldehyde produced in the presence of a catalyst such as hydrochloric acid. Mixtures of such isocyanates may conveniently be incorporated into the compositions of the present invention by incorporating the crude phosgenation product from the above-mentioned phosgenation, making due allowance for the diphenylmethane diisocyanate present therein or alternatively by removing some or all of the diisocyanate component from the crude phosgenation product before incorporation.

Preferred compositions are those containing:

(a) 30 to 75% of diphenylmethane diisocyanate;

(b) 5 to 25% diphenylmethane diisocyanate uretonimine-containing derivative;

(c) 20 to 60% of a reaction product of diphenylmethane diisocyanate and a diol or mixture of diols of number average molecular weight less than 250;

(d) up to 75%, preferably 0.1 to 50% of methylene bridged polyphenyl polyisocyanates of isocyanate functionality higher than two.

The compositions of the invention may be made by blending a diphenylmethane diisocyanate/diol reaction product with a diphenylmethane diisocyanate uretonimine group-containing derivative and diphenylmethane diisocyanate and optionally polymethylene polyphenyl polyisocyanates. Each of the above components may themselves contain free diphenylmethane diisocyanate but further diphenylmethane diisocyanate may be incorporated as desired.

In an alternative process the compositions may be made by mixing a solution of a uretonimine group-containing derivative in diphenylmethane diisocyanate with a diol under such conditions that urethane formation but no other reaction takes place for example at a temperature no higher than 85° C., additional diphenylmethane diisocyanate or higher analogues thereof being optionally present or optionally added later.

In one preferred process for manufacturing the compositions of the present invention, diphenylmethane diisocyanate is first treated with a phosphorus-containing catalyst to convert from 10 to 30% of the isocyanate groups to carbodiimide groups which then react with isocyanate groups to give a solution of a uretonimine derivative in the diisocyanate, there is then added from 50 to 150% of diphenylmethane diisocyanate based on the weight of the original diisocyanate and this mixture is then reacted with one or more diols below 85° C. in such amount as to give a final composition having an isocyanate group content of from 22 to 30%.

The compositions are of low viscosity, and are storage stable liquids. The term liquid is used to indicate that the compositions remain liquid at room temperature down to 0° C. for long periods of time (typically 90 days), sufficient in fact for all practical purposes although on prolonged storage for several years it is possible that some crystallisation will take place. Nevertheless the compositions may for all practical purposes be described as liquids. Thanks to the invention, it is now no longer necessary to heat the container, since the compositions of the invention are storable in a non-heated container, which is also a subject of the invention.

The compositions are useful for the manufacture of polyurethanes in particular. By varying the balance of constituents in the composition it is possible to obtain a wide range of physical properties in the composition especially viscosity and a wide range of processing and polymer properties in the derived polyurethanes. The combination considered to be ideal varies with the precise circumstances of manufacture and product properties demanded.

The compositions of the invention can be used with other isocyanates, such as TDI. All methods of using can be applied, be it one-shot, prepolymer, etc. The invention also provides a process for making a polyurethane comprising reacting at least the composition of the invention with at least one isocyanate-reactive composition.

Finally, the invention provides the polyurethane article obtainable by the foregoing process. This polyurethane article may be selected from the group consisting in microcellular polyurethane, semi-rigid polyurethane, integral skin polyurethane foams, solid polyurethane mouldings, polyurethane encapsulants and polyurethane coatings.

The invention is illustrated by the following non-limiting examples in which all parts are parts by weight except where otherwise stated.

### EXAMPLES

### Comparative Example

2000 g of diphenylmethane-4,4-diisocyanate containing 2% of the 2,4 isomer are heated up to 80° C. with stirring under a Nitrogen blanket, To this molten diisocyanate , 1-Phenyl-3-Methyl-2-phospholene-1-oxide was added in a quantity of 5 parts per million of isocyanate and the temperature was raised to 115° C. When the mixture has reached an isocyanate content of 27.5% the reaction was stopped by addition of 50 ppm Thionyl chloride and cooling the mixture to 80° C. by adding 1050 g of diphenylmethane-4,4-diisocyanate containing 2% of the 2,4 isomer, the final mixture having an isocyanate content of 29.5%. (Sample 1). To this reaction mixture, 87.2 g of a mixture of diols comprising 1,2-propylene glycol, 1,3-butylene glycol and diethylene glycol in a ratio of 1:1.18:1.4 is added over a period of 60 minutes at a temperature of 80° C. After cooling to room temperature the reaction mixture has an isocyanate content of 26.2% and the lightly yellowish liquid has a viscosity at 25° C. of 150 mPas.

### Example 1

2000 g of diphenylmethane-4,4-diisocyanate containing 2% of the 2,4 isomer are heated up to 80° C. with stirring under a Nitrogen blanket, To this molten diisocyanate, 1-Phenyl-3-Methyl-2-phospholene-1-oxide was added in a quantity of 5 parts per million of isocyanate and the temperature was raised to 115° C. When the mixture has reached an isocyanate content of 27.5% the reaction mixture was cooled to 80° C. by adding 1050 g of diphenylmethane-4,4-diisocyanate containing 19% of the 2,4 isomer, the final mixture having an isocyanate content of 29.5%. To this reaction mixture, 87.2 g of a mixture of diols comprising 1,2-propylene glycol, 1,3-butylene glycol and diethylene glycol in a ratio of 1:1.18:1.4 is added over a period of 60 minutes at a temperature of 80° C. After cooling to room temperature the reaction mixture has an isocyanate content of 26.2% and the lightly yellowish liquid has a viscosity at 25° C. of 155 mPas.

### Example 2

2000 g of diphenylmethane-4,4-diisocyanate containing 30% of the 2,4 isomer are heated up to 80° C. with stirring under a Nitrogen blanket, To this molten diisocyanate, 185.7 g of a mixture of diols comprising 1,2-propylene glycol, 1,3-butylene glycol and diethylene glycol in a ratio of 1:1.18:1.4 is added over a period of 60 minutes at a temperature of 80° C. After cooling to room temperature the reaction mixture has an isocyanate content of 23.0% and the lightly yellowish liquid has a viscosity at 25° C. of 1050 mPas. 250 g of this reaction product are blended with 250 g of Sample 1 resulting in an isocyanate with an isocyanate content of 26.2% and a viscosity at 25° C. of 193 mPas at 25° C.

### Example 3

As example 2 but using 2000 g diphenylmethane-4,4-diisocyanate containing 50% of the 2,4 isomer. After blending of 250 g of this reaction product with 250 g of Sample 1, the resulting product has an isocyanate content of 26.2% and a viscosity at 25° C. of 187 mPas.

### Example 4

As example 2 but using 2000 g of diphenylmethane-4,4-diisocyanate containing 2% of the 2,4 isomer. 700 g of this reaction product are blended with 300 g of diphenylmethane-4,4-diisocyanate containing 50% of the 2,4 isomer. The resulting product has an isocyanate content of 26.2% and a viscosity at 25° C. of 166 mPas.

### Example 5

200 g of the product described in example 4 are blended with 1800 g of diphenylmethane-4,4-diisocyanate containing 35% of the 2,4 isomer and 4 g of methylene bridged polyphenyl polyisocyanate of isocyanate functionality higher than 2. The resulting product has an isocyanate content of 32.6%, a viscosity at 25° C. of 13 mPas.

20 g of each product described in the Comparative Example and Examples 1 to 5 were stored at different low temperatures and the number of days were noted by when the first signs of crystallisation appeared. When “no cryst.” is indicated, this means that no sign appears after 90 days; n.a. means not available.

| Storage | | | | | | |
|---|---|---|---|---|---|---|
| cond. | Comp. Ex. | Ex. 1 | Ex. 2 | Ex. 3 | Ex. 4 | Ex. 5 |
| 10° C. | n.a. | n.a. | n.a. | n.a. | n.a. | >30 days |
| 5° C. | 9 days | no | no | no cryst. | no | no cryst. |
| | | cryst. | cryst. | | cryst. | |
| 0° C. | 5 days | 30 days | 39 days | 9 days | n.a. | n.a. |
| −10° C. | <1 day | 2 days | 2 days | 14 days | n.a. | n.a. |

The isocyanates are fully stable, even at very low temperatures.

What is claimed:

1. A diphenylmethane diisocyanate composition that comprises diphenylmethane diisocyanate, a diphenylmethane diisocyanate uretonimine group-containing derivative, a reaction product of diphenylmethane diisocyanate and a diol of number average molecular weight less than 250 and optionally methylene bridged polyphenyl polyisocyanates of isocyanate functionality higher than two, the composition having a content of 2,4 isomer from 3 to 35%.

2. The diphenylmethane diisocyanate composition of claim 1, wherein the content of 2,4 isomer is from 5 to 27%.

3. The diphenylmethane diisocyanate composition of claim 1, wherein the methylene bridged polyphenyl polyisocyanates content is from 10 to 75%.

4. The diphenylmethane diisocyanate composition of claim 2, wherein the methylene bridged polyphenyl polyisocyanates content is from 10 to 75%.

5. The diphenylmethane diisocyanate composition of claim 1, comprising:
a) 30 to 75% of diphenylmethane diisocyanate;
b) 5 to 25% diphenylmethane diisocyanate uretonimine-containing derivative;
c) 20 to 60% of a reaction product of diphenylmethane diisocyanate and a diol or mixture of diols of number average molecular weight less than 250; and
d) up to 75% of methylene bridged polyphenyl polyisocyanates of isocyanate functionality higher than two.

6. The diphenylmethane diisocyanate composition of claim 2, comprising:
e) 30 to 75% of diphenylmethane diisocyanate;
f) 5 to 25% diphenylmethane diisocyanate uretonimine-containing derivative;
g) 20 to 60% of a reaction product of diphenylmethane diisocyanate and a diol or mixture of diols of number average molecular weight less than 250; and
h) up to 75% of methylene bridged polyphenyl polyisocyanates of isocyanate functionality higher than two.

7. The diphenylmethane diisocyanate composition of claim 1, wherein the uretonimine group-containing derivative is made by converting from 3.5 to 35% of the isocyanate groups in diphenylmethane diisocyanate to carbodiimide groups by heating the diisocyanate in the presence of a catalyst, cooling the mixture, deactivating the catalyst if desired and then allowing the carbodiimide groups to react further to give the uretonimine derivative.

8. The diphenylmethane diisocyanate composition of claim 5, wherein the uretonimine group-containing derivative is made by converting from 3.5 to 35% of the isocyanate groups in diphenylmethane diisocyanate to carbodiimide groups by heating the diisocyanate in the presence of a catalyst, cooling the mixture, deactivating the catalyst if desired and then allowing the carbodiimide groups to react further to give the uretonimine derivative.

9. The diphenylmethane diisocyanate composition of claim 1, wherein the reaction product of the diol and diphenylmethane diisocyanate is the reaction product of 0.02 to 0.40 molar, preferably 0.03 to 0.25 molar, most preferably 0.05 to 0.10 molar proportions of diol with 1 molar proportion of diphenylmethane diisocyanate.

10. The diphenylmethane diisocyanate composition of claim 3, wherein the reaction product of the diol and diphenylmethane diisocyanate is the reaction product of 0.02 to 0.40 molar, preferably 0.03 to 0.25 molar, most preferably 0.05 to 0.10 molar proportions of diol with 1 molar proportion of diphenylmethane diisocyanate.

11. The diphenylmethane diisocyanate composition of claim 8, wherein the reaction product of the diol and diphenylmethane diisocyanate is the reaction product of 0.02 to 0.40 molar, preferably 0.03 to 0.25 molar, most preferably 0.05 to 0.10 molar proportions of diol with 1 molar proportion of diphenylmethane diisocyanate.

12. The diphenylmethane diisocyanate composition of claim 1, wherein the composition is stable at 5° C. for more than 90 days without crystallization.

13. The diphenylmethane diisocyanate composition of claim 1, wherein the composition is stable at 0° C. for at least one week without crystallization.

14. The diphenylmethane diisocyanate composition of claim 1, wherein the composition is stable at −10° C. for at least one day without crystallization.

15. A process for the manufacture of the diphenylmethane diisocyanate composition comprising the step of blending a diphenylmethane diisocyanate diol reaction product with a diphenylmethane diisocyanate uretonimine group-containing derivative and diphenylmethane diisocyanate and optionally methylene bridged polyphenyl polyisocyanates of isocyanate functionality greater than two.

16. A process for the manufacture of the diphenylmethane diisocyanate composition comprising the step of mixing a solution of a uretonimine group-containing derivative of diphenylmethane diisocyanate in diphenylmethane diisocyanate with a diol or mixture of diols under such conditions that urethane formation occurs but no other reaction takes place, and optionally methylene bridged polyphenyl polyisocyanates having an isocyanate functionality greater than two.

17. A process for the manufacture of the diphenylmethane diisocyanate composition comprising the steps of:
(a) treating diphenylmethane diisocyanate with a phosphorus-containing catalyst to convert from 10 to 30% of the isocyanate groups to carbodiimide groups, which then react with isocyanate groups to give a solution of the uretonimine group-containing derivative in the diisocyanate;
(b) adding from 50 to 150% of diphenylmethane diisocyanate, based on the weight of the original diisocyanate, to the treated diphenylmethane diisocyanate in (a);
(c) reacting the mixture of (a) and (b) with one or more diols below 85° C. in such amount as to give a final composition having an isocyanate group content of from 22to 30%; and
(d) optionally, adding methylene bridged polyphenyl polyisocyanates having an isocyanate functionality greater than two to the composition in (c).

18. A process for making a polyurethane comprising the step of reacting:
(a) at least a diphenylmethane diisocyanate composition that comprises diphenylmethane diisocyanate, a diphenylmethane diisocyanate uretonimine group-containing derivative, a reaction product of diphenylmethane diisocyanate and a diol of number average molecular weight less than 250 and optionally methylene bridged polyphenyl polyisocyanates of isocyanate functionality higher than two, the composition having a content of 2,4 isomer from 3 to 35%; and
(b) at least one isocyanate-reactive composition.

19. The process of claim 18, wherein the content of 2,4 isomer is from 5 to 27%.

20. The process of claim 18, wherein the methylene bridged polyphenyl polyisocyanates content is from 10 to 75%.

21. The process of claim 18, wherein the uretonimine group-containing derivative is made by converting from 3.5 to 35% of the isocyanate groups in diphenylmethane diisocyanate to carbodiimide groups by heating the diisocyanate in the presence of a catalyst, cooling the mixture, deactivating the catalyst if desired and then allowing the carbodiimide groups to react further to give the uretonimine derivative.

22. The process of claim 18, wherein the reaction product of the diol and diphenylmethane diisocyanate is the reaction product of 0.02 to 0.40 molar, preferably 0.03 to 0.25 molar, most preferably 0.05 to 0.10 molar proportions of diol with 1 molar proportion of diphenylmethane diisocyanate.

23. A polyurethane article obtained from the reaction of:
(a) at least a diphenylmethane diisocyanate composition that comprises diphenylmethane diisocyanate, a diphenylmethane diisocyanate uretonimine group-containing derivative, a reaction product of diphenylmethane diisocyanate and a diol of number average molecular weight less than 250 and optionally methylene bridged polyphenyl polyisocyanates of isocyanate functionality higher than two, the composition having a content of 2,4 isomer from 3 to 35%; and
(b) at least one isocyanate-reactive composition.
